(19) United States
(12) Patent Application Publication
(10) Pub. No.: US 2014/0324442 A1
(43) Pub. Date: Oct. 30, 2014

(54) SYSTEM AND METHOD FOR ALERTING GOVERNMENT REPRESENTATIVES TO CITIZEN ISSUES

(71) Applicant: George Barnes, III, Miami, FL (US)

(72) Inventor: George Barnes, III, Miami, FL (US)

(21) Appl. No.: 14/263,705

(22) Filed: Apr. 28, 2014

Related U.S. Application Data
(60) Provisional application No. 61/816,682, filed on Apr. 26, 2013.

(51) Int. Cl. G06Q 50/26; H04L 12/24

(52) U.S. Cl. CPC G06Q 50/26; H04L 41/22
USPC 705/1.1

(57) ABSTRACT

A system for alerting government representatives to citizen issues, including a user interface; a wireless communications module; a processor; and a tangible non-transitory computer-readable memory having instructions, that when executed by the processor, cause the processor to perform the steps of: receiving evidence; receiving, via the user interface, personal data of a user; generating a list of government representatives; receiving, via the user interface, a selection of government representatives; populating a petition with the evidence, personal data, and the selection of government representative; and transmitting, via the wireless communications module, the petition to the government representatives.

### CROSS-REFERENCE TO RELATED APPLICATIONS

This application incorporates by reference and claims the benefit of priority to U.S. Provisional Patent Application No. 61/816,682 filed Apr. 26, 2013.

### BACKGROUND OF THE INVENTION

The present subject matter relates generally to systems and methods for alerting government representatives, such as legislators, councilpersons, etc., to issues of citizen concern. More specifically, the present invention relates to systems and methods for alerting government representatives to issues of citizen concern by enabling the user to efficiently document the issue, prepare a petition describing the issue, find the appropriate government representatives, and submit the petition to the government representatives.

Citizens in a modern democracy have a need to alert authorities, including legislators, representatives, police, etc., of unsafe, illegal, or otherwise problematic issues in their community. However, it can often be a time consuming process to document the issue, prepare a petition, and submit the petition to the appropriate representative. Often, a user is unaware of who represents a particular location, and is unaware of the government representatives' contact information, especially if it involves federal or State jurisdiction. Due to the difficulty in alerting government representatives to issues, a concerned citizen may give up before the issue has been brought to the attention of the proper authorities.

As a simple example, a common concern of citizens is the illegal dumping of environmental hazards, illegal or dangerous waste, human rights violations, health and welfare, or other issues that may be overseen by elected representatives for that area serving at the US Congress Federal, State or, or even at the local level. Other issues may include garbage in otherwise abandoned or poorly visited areas, public safety concerns, code violations in a town, etc. A concerned citizen may wish to bring the issue up with the appropriate Local, State, or Federal government elected representative, agency, or if applicable, local city council representative to encourage action, urge a change in public policy, or otherwise address the issue. Currently, a user must take considerable pains to assemble photographic and other evidence, compose a petition, determine the correct city council, State, or Federal representative, obtain an address or electronic contact information including a direct phone number, send the petition to the appropriate representative or agency, and be able to easily follow up with a phone call to that representative or agency.

Accordingly, there is a need for systems and methods for easily alerting government representatives, to issues of citizen concern, as described herein, combined with the ability for an easy follow up phone call and further dissemination of the issue.

### BRIEF SUMMARY OF THE INVENTION

To meet the needs described above and others, the present disclosure provides systems and methods for alerting government representatives, such as legislators, councilpersons, agencies etc., to issues of citizen concern.

The present disclosure discloses an alert system and alert method for alerting relevant authorities to issues discovered by a citizen using the system. The system provides a mechanism to visually document evidence of the issue, prepare a petition to the relevant authority, and submit the petition electronically. The system further provides mechanisms to share the evidence with social networks and social media and follow up with a phone call by using this technology to provide a one-click ability to call the appropriate agency/representative/official phone number.

In a preferred embodiment, the system may be a commercially available mobile device including instructions that when executed by a processor provide the functionality of the present disclosure. In the preferred embodiment, when a user encounters an issue, the user may execute stored instructions, for example by launching an application on the device. The smartphone may then proceed to execute the steps as disclosed further herein.

For example, if the user sees an occurrence of environmental atmospheric dumping, the user may launch an application on the device to cause the device to execute the functionality described herein. The device may then provide an input screen to allow the user to document the issue by collecting evidence. In an embodiment, the input screen may allow the user to take a photograph using the device to capture visual evidence. In other embodiments, the input screen may allow the user to capture evidence by recording a video, recording audio, imputing a text narrative description of the issue/observation/concern or otherwise making a record of a sensor input available to the device.

The device may also provide an issue input screen for the user to select the issue that has occurred. For example, the issue input screen may prompt the user to indicate whether the issue is “illegal environmental dumping,” “unsafe road condition,” “illegal activity,” “Social Injustice” etc. Alternatively, in a preferred embodiment, the application is provided as a single use application for documenting a specific violation and no issue input screen is provided. Based on the issue, the device may then ask for further information about the evidence collected, or suggest the collection of further evidence.

The device may then prompt the user for personal data for inclusion in any petition or letter. The intended recipient of the petition may use the personal data to validate that the user is a constituent. For example, in an embodiment, the device may prompt the user to input their first and last name, address, city, zip, and email address. In an alternative embodiment, the device may prompt the user for personal data when the device is first used, thus permitting the device to bypass the personal data prompt during subsequent use by auto-populating the personal data.

The device may then generate a list of government representatives representing the area having oversight or interest in the issue. In an embodiment, the device may use a geo-location tag associated with the evidence to determine a location of the issue. In a preferred embodiment, a latitude and longitude may be extracted from an image taken on a smartphone. The latitude and longitude may be compared with a database defining the boundaries of various governmental representative districts to determine the district containing the latitude and longitude of the issue. Upon determining the districts that the issue is located in, the device may determine the various government representatives associated with those districts and assemble contact information for the various government representatives.

After generating a list of government representatives, the user may be prompted to select the government representatives from the list that the user intends to petition.

The device may then populate a petition with the evidence, personal information, and government representative information. In an embodiment, the petition may include a form petition to the government representative including text referencing the evidence and including the attached evidence. For example, visual evidence may be included in the form of a photo, inline with the text of the form petition or user input text. In addition, the device may include the personal information as a signature block. Further, the government representative information may be included as a salutation. The device may populate the petition with any information collected about the user or about the evidence as previously described.

Where the evidence is not amenable to being directly included in the petition, for example, where the evidence is video evidence, the petition may include a reference to the resource. For example, where the evidence is video evidence, the device may upload the video evidence to an Internet location and include a reference to the Internet location in the petition.

After assembling the information in the petition, the petition may be prepared for transmission. In an embodiment, the petition is assembled into an electronic correspondence or compressed into a tinyURL with or without links for photos or video for dissemination via Twitter, or other agencies, representatives, or community social networks and government representatives. The electronic correspondence may be addressed to the government representatives or agencies using the contact information retrieved for the government representatives or agencies.

The device may then transmit the petition to the representatives. In an embodiment, the device transmits the petition via email or other form of electronic communication to the representatives. In alternate embodiments, the user may transmit the petition via social media. For example, the user may post a reference to the petition and/or the evidence on a microblog or social network, such as Twitter or Facebook, and may tag or reference a public profile of a government representative in a way viewable by the profile of the government representative.

In an embodiment, a system for alerting government representatives to citizen issues, includes: a processor; a user interface controlled by the processor; a wireless communications module controlled by the processor; and tangible non-transitory computer-readable media having instructions, that when executed by the processor, cause the processor to perform the steps of: receiving evidence; receiving personal data of a user; receiving, via the user interface, a selection of one or more government representatives; populating a petition with the evidence, personal data, and the selection of one or more government representatives; and transmit, via the wireless communications module, the petition to the selected government representatives.

In some embodiments, the system further includes a camera controlled by the processor, wherein the evidence is received via the camera, and wherein the evidence is one of a video or an image. Additionally, in some embodiments, the evidence include an image and a geo-location tag. Further, in some embodiments, the computer-readable memory includes further instructions, that when executed by the processor, cause the processor to perform the further step of: receiving, via the user interface, an input of an issue type. Moreover, in further embodiments, the processor selects a template petition based on the selected issue type.

In some embodiments, the computer-readable memory includes further instructions, that when executed by the processor, cause the processor to perform the further step of: generating a list of government representatives. Additionally, in some embodiments, the evidence includes a geo-location tag, and the list of government representatives includes government representatives of one or more districts including a location represented by the geo-location tag. Further, in some embodiments, the computer-readable memory includes further instructions, that when executed by the processor, cause the processor to perform the further step of: receiving, via the user interface, an input of an issue type; and wherein the list of government representatives includes government representatives associated with the issue type.

In some embodiments, the evidence is populated in the petition by including in the petition a reference to an Internet location of the evidence. Additionally, in some embodiments, the processor, upon detecting stored personal data, skips the step of receiving, via the user interface, the personal data of a user. Further, in some embodiments, the step of transmitting the petition to the government representatives is accomplished by posting the petition to a social network along with a tag referencing a public profile of a government representative. Even further, in some embodiments, the evidence is populated in the petition by including a reference to an Internet location of the evidence in the petition.

In an embodiment, a system for alerting government representatives to citizen issues, includes: a processor; a user interface controlled by the processor; a camera controlled by the processor; a wireless communications module controlled by the processor; and a tangible non-transitory computer-readable media having instructions, that when executed by the processor, cause the processor to perform the steps of: receiving evidence, wherein the evidence is received via the camera, wherein the evidence is one of a video or an image, and wherein the evidence includes a geo-location tag; receiving personal data of a user; receiving, via the user interface, an input of an issue type; receiving, via the user interface, a selection of government representatives; generating a list of government representatives, wherein the list of government representatives includes government representatives of one or more districts including a location represented by the geo-location tag; populating a petition with the evidence, personal data, and the selection of government representative, wherein the petition is selected based on the selected issue type; and transmitting, via the wireless communications module, the petition to the selected government representatives.

In some embodiments, the step of transmitting the petition to the government representatives is accomplished by posting the petition to a social network along with a tag referencing a public profile of a government representative. Additionally, in some embodiments, the evidence is populated in the petition by including in the petition a reference to an Internet location of the evidence.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates the ecosystem of an example petitioning system embodied in a device, such as a smartphone.

FIG. 2 is a block diagram representation of an example implementation of a device.

FIG. 3 is a flowchart of an example method according to the teachings provided herein.

FIG. 4 is a screenshot of an evidence input screen of the example device of FIG. 1.

FIG. 5 is a screenshot of an issue input screen of the example device of FIG. 1.

FIG. 6 is a screenshot of a personal data screen of the example device of FIG. 1.

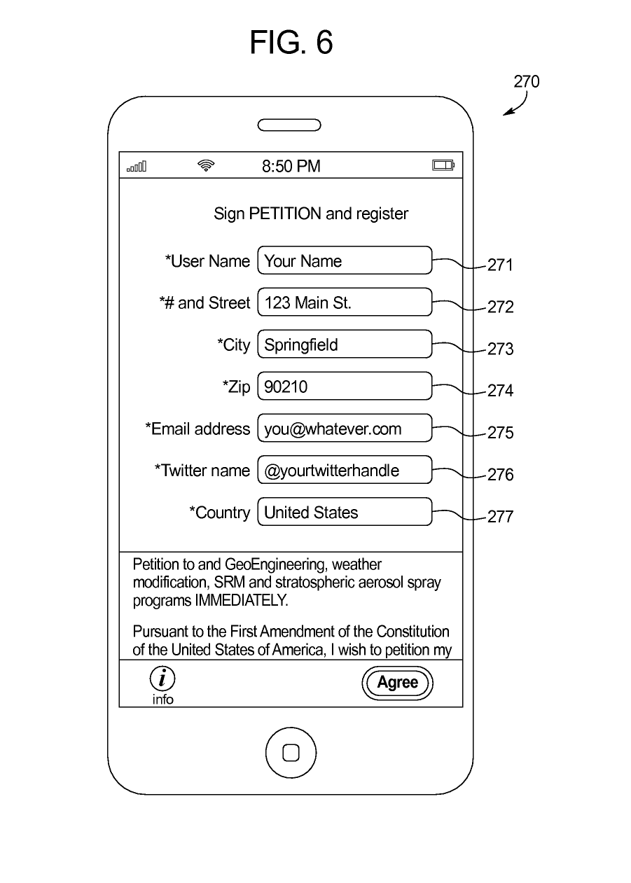

FIG. 7 is a screenshot of a selection and review screen of the example device of FIG. 1.

FIG. 8 is an example petition generated by the system of FIG. 1.

FIG. 9 is a screenshot of a confirmation screen of the example device of FIG. 1.

FIG. 10 is a screenshot of a microblog screen of the example mobile of FIG. 1.

FIG. 11 is a screenshot of a social network screen of the example device of FIG. 1.

### DETAILED DESCRIPTION OF THE INVENTION

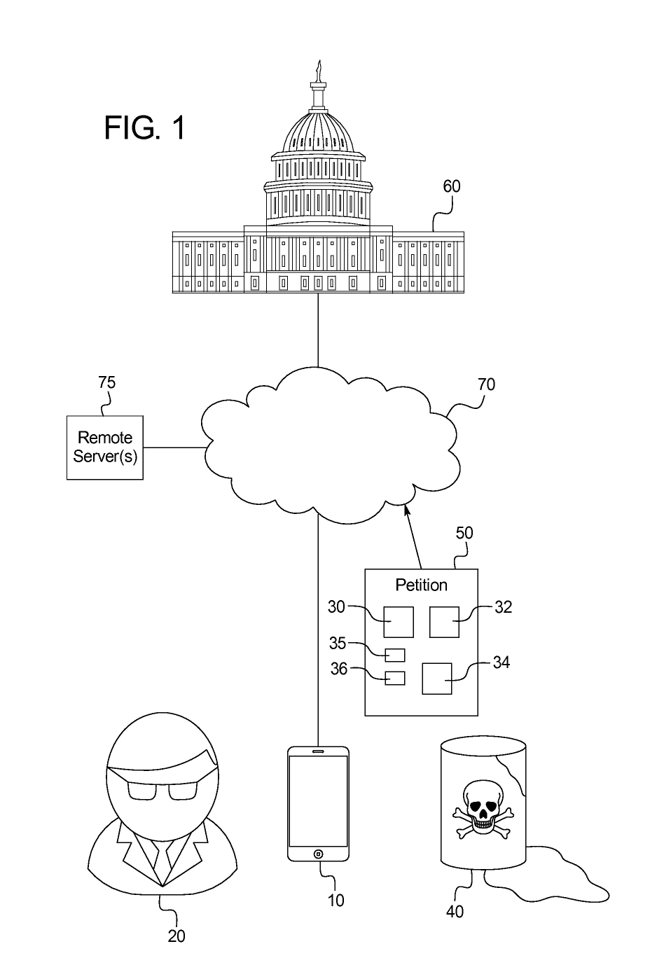

FIG. 1 illustrates the ecosystem of an example petitioning system embodied in a device 10, such as a smartphone. A user 20 may use the device 10 to record evidence 30 of an issue 40 and transmit the evidence 30, over a communications network 70, as part of a petition 50 to a governmental representative 60 such as a local, state, or federal agency, elected representative, bureaucrat, government agent, law enforcement, organization, business, or any other organization or person capable of being petitioned by the user 20.

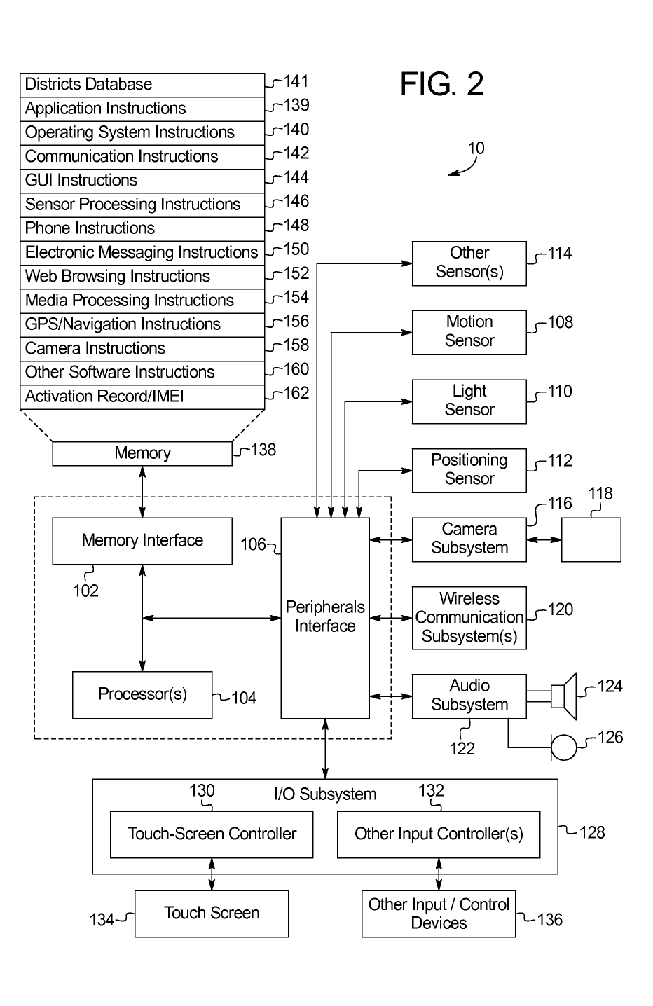

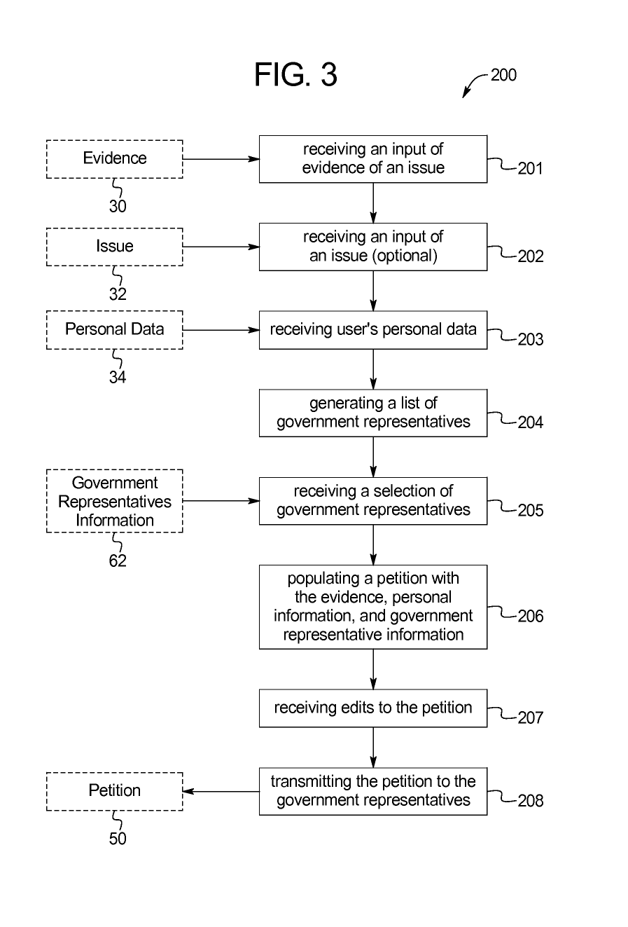

FIG. 2 is a block diagram representation of an example implementation of a mobile device 10. The device 10 may include instructions for performing the method 200 as shown in FIG. 3. As shown in FIG. 2, the device 10 includes a processor 104, a memory 138, a camera 118, a positioning sensor 112, wireless communication subsystems 120, and a touch screen 134. In a preferred embodiment, the device 10 may be a commercially available smartphone including application instructions 139 stored on the memory 138 that, when executed by the processor 104, perform the method 200 of the present disclosure. In the preferred embodiment, when a user 20 encounters an issue 40, the user 20 may execute the stored application instructions 139, for example, by launching an application on the mobile device 10. The mobile device 10 may then proceed to execute the steps as disclosed further herein.

In one example, if the user 20 sees an occurrence of environmental atmospheric dumping, the user 20 may launch an application on the device 10 to cause the device 10 to execute the method 200. As shown in FIG. 3, the method 200 includes: step 201 of receiving an input of evidence 30 of an issue type 32; optional step 202 of receiving an input of an issue type 32; step 203 of receiving user's personal data 34; step 206 of generating a list of government representatives; step 206 of receiving a selection of government representatives 60; step 206 of populating a petition 50 with the evidence 30, personal data 34, and the selection of government representative 60; step 208 of transmitting the petition 50 to the government representatives 60. In an alternative embodiment, after step 201, the device may perform any or all of the steps 202-208 automatically by auto-populating all the required information, thus permitting the user 20 to accomplish the whole process with a single button click.

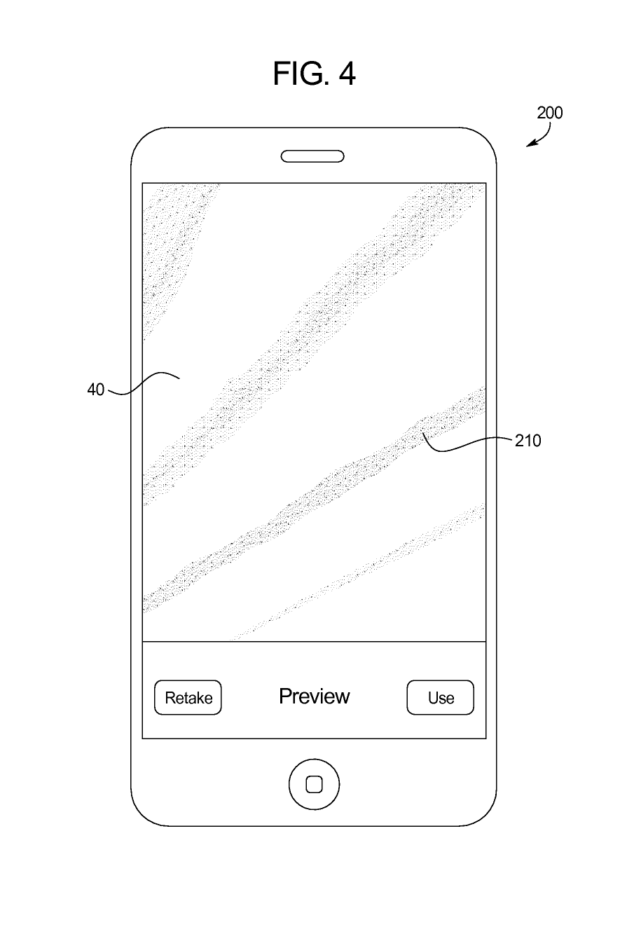

At step 201, the device 10 may receive an input of evidence 30 of an issue. As shown in FIG. 4, the device 10 may provide an input screen 200 on the display 70 to allow the user 20 to document the issue 40 by collecting evidence 30. In a preferred embodiment, the input screen 200 may allow the user 20 to take a photograph 210 using the camera 118 of the device 10 to capture visual evidence 30. In the preferred embodiment, when taking a photograph 210, the device 10 captures the location of the device 10 using the positioning sensor 112 and stores the location as a geo-location tag 35. In other embodiments, the input screen 200 may allow the user 20 to capture evidence 30 by recording a video using the camera 118, recording audio using the microphone 126, or otherwise making a record of any sensor input available to the device 10, such as the positioning sensor 112, the light sensor 110, the motion sensor 108, or other sensors 114. When capturing evidence 30, the device 10 may associate a timestamp 36 with the evidence 30 to document the time when the evidence 30 was collected.

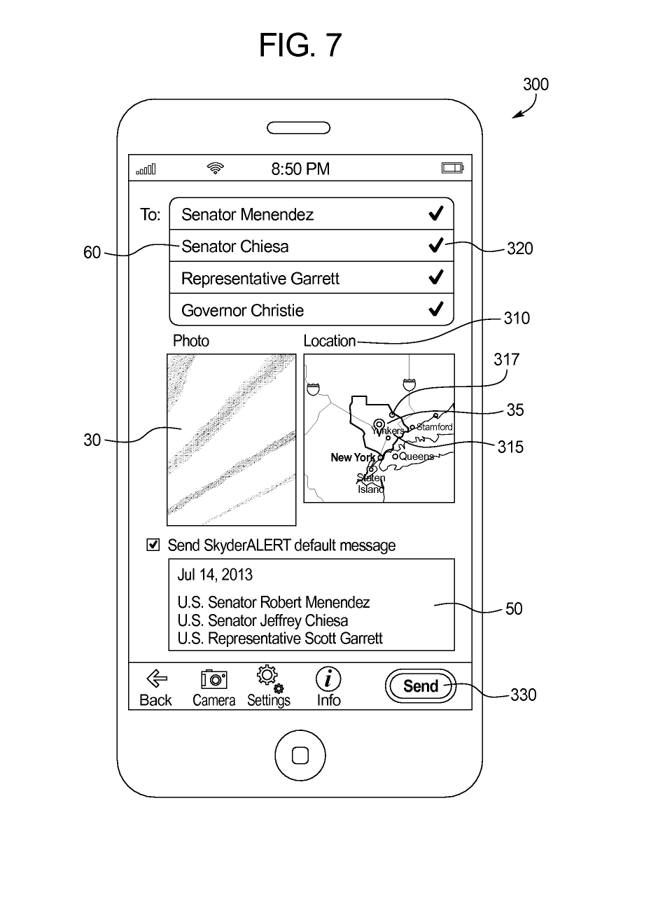

At optional step 202, the device 10 may receive an input of an issue type 32 by providing an issue input screen 230 for the user 20 to select the issue type 32 that has been documented. For example, the issue input screen 230 may prompt the user 20 with a dropdown box 240 to indicate whether the issue 40 is “illegal environmental dumping”, “unsafe road condition”, “illegal activity”, etc. Alternatively, in a preferred embodiment, the application instructions 139 may be provided as a single use mobile application for documenting a specific violation and no issue input screen 230 is provided. Based on the issue 40, the device 10 may then request for further information about the evidence 30 collected to explain the evidence 30, explain the method of collection, etc. In further embodiments, the user 20 may be permitted to edit a generic issue template by selecting an edit button 250 to customize a generic template to fit the issue 40. For example, if a user 20 wishes to report a pothole, the user 20 may select and modify a generic template concerning “unsafe road conditions” to create a petition 50 for the issue 40. If the user 20 has previously inputted personal data 34, the user 20 may select the auto-populate button 260 to proceed directly to the selection and review screen 300 (FIG. 7).

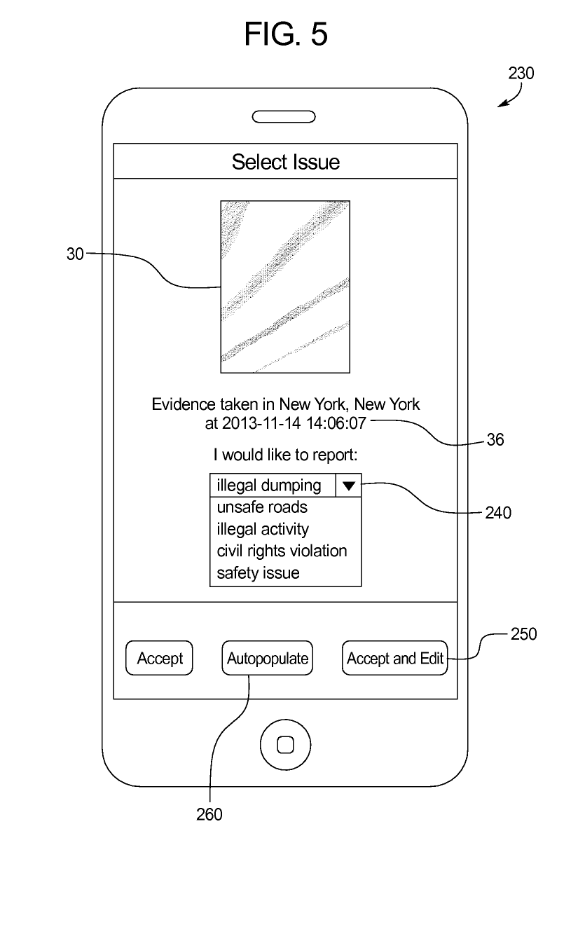

At step 203, the device 10 may receive a user's personal data 34 by prompting the user 20 for personal data 34 for inclusion in any petition 50 as shown in the personal data screen 270 shown in FIG. 5. The governmental representative 60 may use the personal data 34 to validate that the user 20 is a constituent. For example, in an embodiment, the device 10 may prompt the user 20 to input their name 271, address 272, city and state 273, zip code 274, email address 275, twitter name or other social media handle 276, and country 277. In an alternative embodiment, the device 10 may prompt the user 20 for personal data 34 when the device 10 is first used, thus permitting the device 10 to bypass the personal data screen 270 during subsequent use by auto-populating the personal data 34.

Turning to FIG. 7, at step 204, the device 10 may then generate a list 320 of government representatives 60 representing the location 310 of the issue 40. In an embodiment, the device 10 may use a geo-location tag 35 associated with the evidence 30 to determine a location 310 of the issue. In a preferred embodiment, a latitude and longitude 315 may have been captured when capturing the evidence 30. The latitude and longitude 315 may be compared with a districts database 141, stored locally or accessed remotely, defining the boundaries of various districts 317 of the governmental representatives 60 districts to determine the district 317 containing the latitude and longitude 315 of the issue 40. Upon determining the districts 317 that the issue 40 is located in, the device 10 may determine the various government representatives 60 associated with those districts 317 and access contact information 64 for the various government representatives 60 from the districts database 141 or from a remote server 75.

Additionally, in some embodiments, government representatives 60 may be determined based on the issue type 32. For example, a petition 50 may be directed to government representatives 60 that serve on committees related to the issue 40 or are otherwise related to the issue 40. The device 10 may lookup the government representatives 60 relating to the issue type 32 from the districts database 141 or from a remote server 75, or from other sources on a remote server 75 relating government representatives 60 to issues.

At step 205, in the selection and review screen 300, after generating a list of government representatives 60, the user 20 may be prompted to select the government representatives 60 from the list 320 that the user 20 intends to petition. For example, as shown in FIG. 7, the user 20 may be prompted to select any or all government representatives 60 from a list including Senators, the local Representative, and the Governor. In further embodiments, the user 20 may be permitted to select city council members, police representatives, health and safety representatives, media representatives, etc.

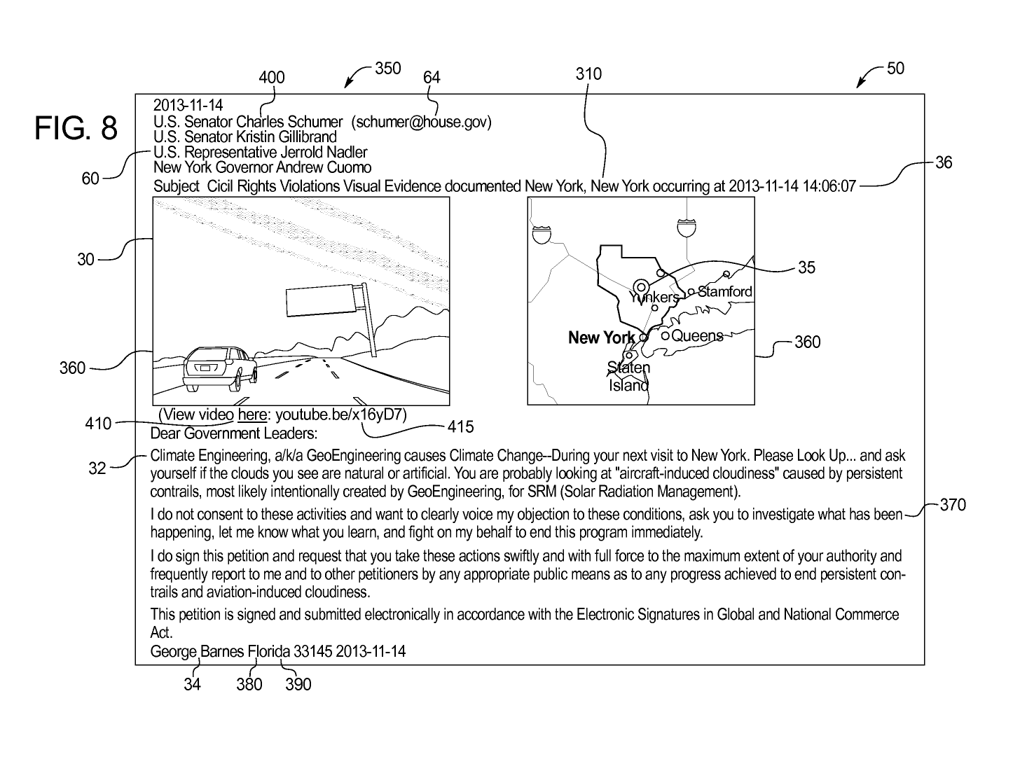

At step 206, as shown in FIG. 8, the device 10 may then populate a petition 50 with the evidence 30, issue type 32, personal data 34, and the government representative information 62. In an embodiment, the petition 50 may be constructed by populating a template petition 350 to the government representative 60 including boilerplate and computer-generated text 370 referencing the evidence 30 and substitution placeholders 360 for receiving the evidence 30, personal information 34, and government representative information 62. For example, visual evidence 30 may be included inline with the text 370 of the template petition 350 by replacing a substitution placeholder 360 for visual evidence 30. As another example, the device 10 may include the a portion of the personal data 30, such as the name 271 and city and state 273, as a signature block 380 replacing a signature placeholder 390. As a further example, the government representative information 62 may be included as a salutation replacing a government representative placeholder 400. One of skill in the art will recognize that the device 10 may populate the petition 50 with any information collected about the user 20, about the evidence 30, or about the issue 40 as previously described.

Where the evidence 30 is not amenable to being directly included in the petition 50, the petition 50 may include a reference 410 to the evidence 30 in place of the evidence 30 itself. For example, where the evidence 30 is video evidence 30, the device 10 may upload the video evidence 30 to an Internet location 415 and include a reference 410 to the Internet location 415 in the petition 50.

After assembling the information in the petition 50, the petition 50 may be prepared for transmission. In an embodiment, the petition 50 is assembled into an email or emails or other form of electronic communication and addressed to the government representatives 60. The emails may be addressed to the government representatives 60 using the contact information retrieved for the government representatives 60. In other embodiments, the petition may be assembled as a PDF (portable document format) or TinyURL document suitable for printing, fax mail, text, email, posting, or social sharing transmission.

At step 207, as shown in the selection and review screen 300 in FIG. 7, the user 20 may then review the petition 50 and make changes. Once the user 20 is satisfied with the petition 50, the user 20 may indicate to the device 10 to transmit the petition 50 by selecting the send button 330.

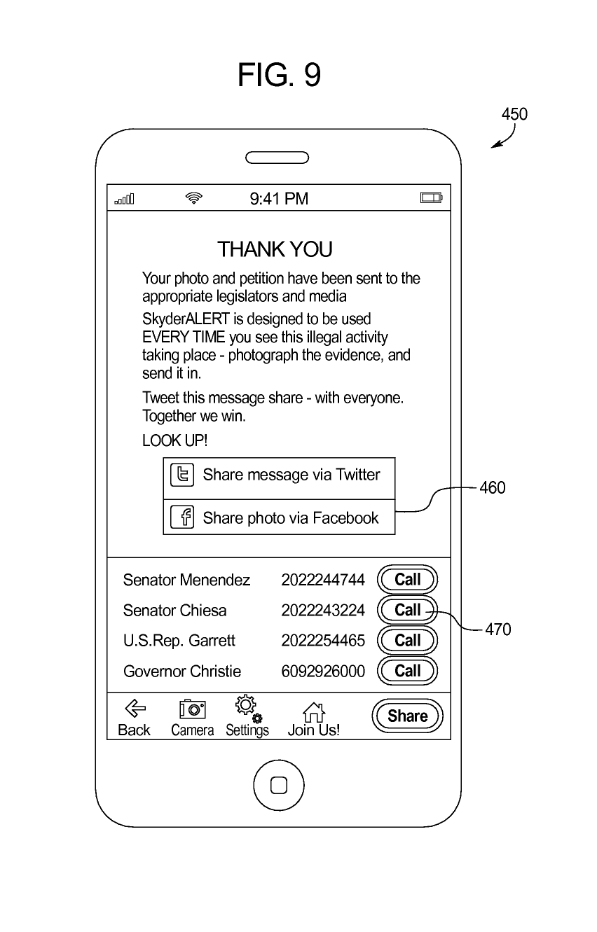

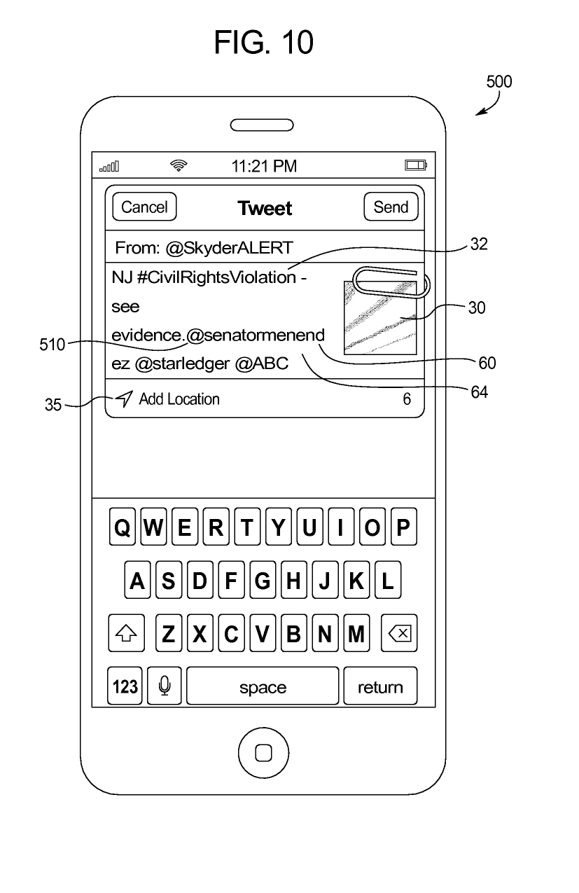

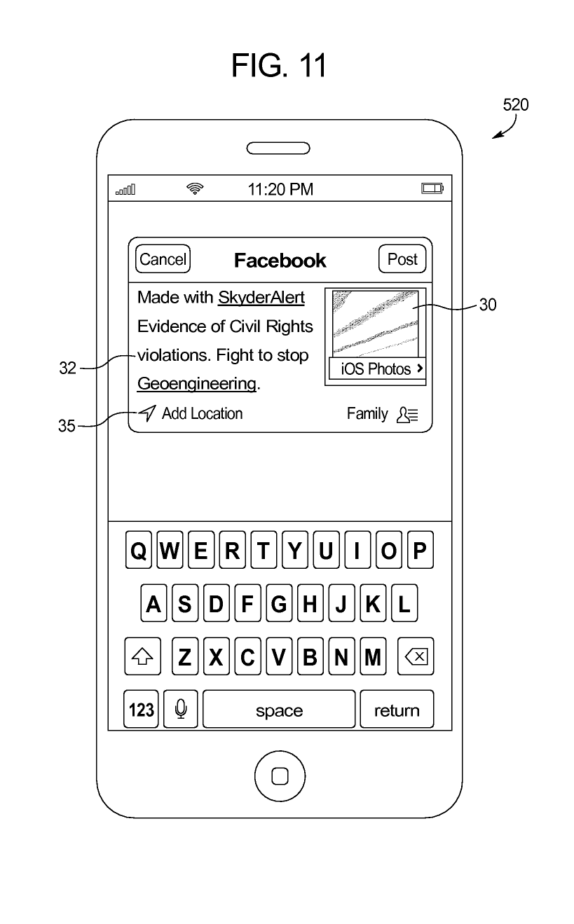

At step 208, the device 10 may then transmit the petition 50 to the government representatives 60 and display a confirmation screen 450 as shown in FIG. 9. On the confirmation screen 450, the user 20 may be presented with call buttons 470 to follow up the petition submission with a phone call to the government representative 60. In an embodiment, the device 10 transmits the petition 50 via email or other electronic submission to the government representatives 60. In alternate embodiments, the device 10 may transmit the petition and/or evidence via fax across a cellular network accessed by the wireless communication subsystems 120. In further embodiments, the user 20 may additionally or alternatively transmit the petition 50 and/or evidence via social media. For example, as shown in FIGS. 10 and 11, the user 20 may select a share button 460 to post a reference 410 to the petition 50 and/or the evidence 30 on a microblog or social network, as shown in the Twitter screen 500 or the Facebook screen 520, and may create a tag 520 referencing a public profile of a government representative 60 in a way viewable by the profile of the government representative 60. It is contemplated that nearly any mechanism to communicate with government representatives 60 may be used as will be apparent to one of skill in the art.

Referring back to FIG. 2, the mobile device 10 includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the mobile device 10 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 10 is intended to operate. For example, the mobile device 10 can include communication subsystems 120 designed to operate over a GSM network, a GPRS network, an EDGE network, a Wi-Fi or WiMax network, and a Bluetooth network. In particular, the wireless communication subsystems 120 may include hosting protocols such that the mobile device 10 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers 75. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the mobile device 10 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the mobile device 10 may be implemented in hardware and/or in software, including in one or more signal processing and/or application specific integrated circuits. Accordingly, the mobile device 10, as shown in FIG. 2, may be adapted to perform any combination of the functionality described herein.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for alerting government representatives to citizen issues, comprising:
a processor;
a user interface controlled by the processor;
a wireless communications module controlled by the processor; and
tangible non-transitory computer-readable media having instructions, that when executed by the processor, cause the processor to perform the steps of:
receiving evidence;
receiving personal data of a user;
receiving, via the user interface, a selection of one or more government representatives;
populating a petition with the evidence, personal data, and the selection of one or more government representatives; and
transmit, via the wireless communications module, the petition to the selected government representatives.

2. The system of claim 1, further including a camera controlled by the processor, wherein the evidence is received via the camera, and wherein the evidence is one of a video or an image.

3. The system of claim 1, wherein the evidence include an image and a geo-location tag.

4. The system of claim 1, wherein the computer-readable memory includes further instructions, that when executed by the processor, cause the processor to perform the further step of:
receiving, via the user interface, an input of an issue type.

5. The system of claim 4, wherein the processor selects a template petition based on the selected issue type.

6. The system of claim 1, wherein the computer-readable memory includes further instructions, that when executed by the processor, cause the processor to perform the further step of:
generating a list of government representatives.

7. The system of claim 6, wherein the evidence includes a geo-location tag, and wherein the list of government representatives includes government representatives of one or more districts including a location represented by the geo-location tag.

8. The system of claim 6, wherein the computer-readable memory includes further instructions, that when executed by the processor, cause the processor to perform the further step of:
receiving, via the user interface, an input of an issue type; and
wherein the list of government representatives includes government representatives associated with the issue type.

9. The system of claim 1, wherein the evidence is populated in the petition by including in the petition a reference to an Internet location of the evidence.

10. The system of claim 1, wherein the processor, upon detecting stored personal data, skips the step of receiving, via the user interface, the personal data of a user.

11. The system of claim 1, wherein the step of transmitting the petition to the government representatives is accomplished by posting the petition to a social network along with a tag referencing a public profile of a government representative.

12. The system of claim 11, wherein the evidence is populated in the petition by including a reference to an Internet location of the evidence in the petition.

13. A system for alerting government representatives to citizen issues, comprising:
a processor;
a user interface controlled by the processor;
a camera controlled by the processor;
a wireless communications module controlled by the processor; and
a tangible non-transitory computer-readable media having instructions, that when executed by the processor, cause the processor to perform the steps of:
receiving evidence, wherein the evidence is received via the camera, wherein the evidence is one of a video or an image, and wherein the evidence includes a geo-location tag;
receiving personal data of a user;
receiving, via the user interface, an input of an issue type;
receiving, via the user interface, a selection of government representatives;
generating a list of government representatives, wherein the list of government representatives includes government representatives of one or more districts including a location represented by the geo-location tag;
populating a petition with the evidence, personal data, and the selection of government representative, wherein the petition is selected based on the selected issue type; and
transmitting, via the wireless communications module, the petition to the selected government representatives.

14. The system of claim 13, wherein the step of transmitting the petition to the government representatives is accomplished by posting the petition to a social network along with a tag referencing a public profile of a government representative.

15. The system of claim 14, wherein the evidence is populated in the petition by including in the petition a reference to an Internet location of the evidence.
